(19) United States
(12) Patent Application Publication
(10) Pub. No.: US 2006/0193967 A1
(43) Pub. Date: Aug. 31, 2006

(54) Marshmallow containing a soft textured chocolate center

(76) Inventor: Christy Lee Tucker, Bellingham, WA (US)

Correspondence Address: Christy Lee Tucker, 1370 S. Parkstone Ct., Bellingham, WA, 98229, US

(21) Appl. No.: 11/065,604

(22) Filed: Feb. 25, 2005

(51) Int. Cl. A23G 3/00

(52) U.S. Cl. 426/660

(57) ABSTRACT

The present invention is a marshmallow containing a soft texture chocolate filling. When roasted the chocolate inside the marshmallow becomes slightly melted and is soft. When this invention is used in the making of smores, it allows for a more convenient, a smoother-textured, and a more enjoyable smore.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

Smores are a favorite campfire tradition and have been enjoyed for many years. Traditionally made by gently roasting a marshmallow on a stick over an open flame, then sandwiching between two graham crackers along with a piece of chocolate from a candy bar. While the marshmallow is of a soft and melted consistency the chocolate is traditionally hard and not melted. The invention described in this application places a soft textured chocolate in the center of the marshmallow allowing the chocolate to become soft and slightly melted as the marshmallow is roasted. This invention will give a unique and convenient option in the making of smores.

As a child, I personally would insert a piece of a chocolate bar into the marshmallow before roasting. This was not convenient as it made a sticky mess, because the chocolate was hard to begin with it never melted through. And because of the large hole it left in the marshmallow, the marshmallow and chocolate often ended up falling off the stick and into the fire.

Through trial and error I have created the invention described in this application that achieves the effect I wanted. The chocolate is melted with the marshmallow, and of a soft consistency, making the taste and texture smooth, slightly melted when roasted, and more enjoyable. The sticky mess is reduced and it goes easily on and off of a roasting stick.

### BRIEF SUMMARY OF INVENTION

The invention described in this application gives a new twist on an old favorite. The marshmallow filled with a soft textured chocolate allows for the chocolate to become warm and slightly melted when the marshmallow is roasted. This creates a warm and melted version of a smore when placed between two graham crackers. The chocolate is of a consistency that allows a roasting stick to be easily inserted for roasting, however it is firm enough that the majority of the chocolate will remain in the marshmallow and not leak out.

### BRIEF DESCRIPTION OF DRAWING

FIG. 1A This drawing shows the inside view of the marshmallow with the soft textured chocolate as if the marshmallow were cut in half.

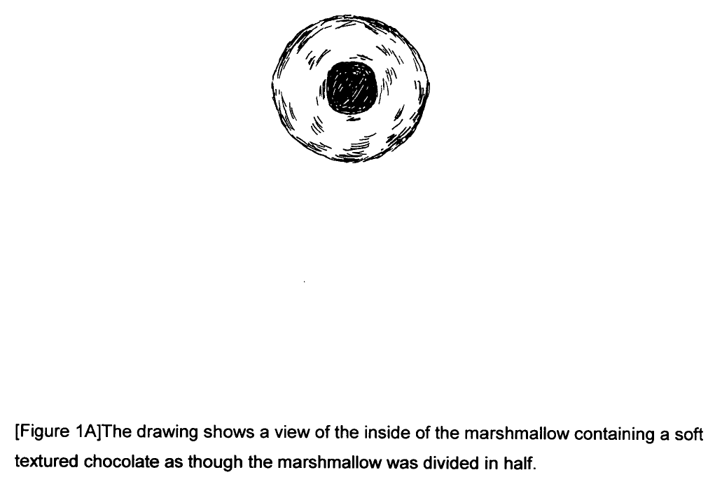

### DETAILED DESCRIPTION OF INVENTION

The invention submitted in this application is a marshmallow with a soft textured chocolate filling for the purpose of roasting, use in making smores, and eating. A marshmallow with an inner filling of soft textured chocolate allows for the chocolate to become warm and slightly melted when roasted on a roasting stick or other utensil. When the roasted chocolate filled marshmallow is then placed between two graham crackers, it makes a smore with a warm and slightly melted chocolate of a smooth consistency.

In the past, smores have been made with a roasted marshmallow and piece of a chocolate bar which in contrast to the marshmallow is hard, not melted. The roasted marshmallow and piece of chocolate bar are then sandwiched between two graham crackers.

This invention allows for the convenience of combining the marshmallow and chocolate, thereby eliminating a step, reducing the making of smores to only two ingredients.

This invention allows for the chocolate in the smore to be of a smooth and slightly melted consistency compliementing the smooth and slightly melted consistency of the roasted marshmallow, rather than the traditional method of making smores with a hard, non melted piece of a chocolate bar.

To make a smore using a marshmallow containing a soft textured chocolate, place a roasting stick, or other desired utensil, through the center or, approximately the center of the marshmallow. Gently roast over an open flame, not so close as to light it on fire, but near enough that the outside of the marshmallow gradually bubbles and the outside of the marshmallow caramelizes. Then remove the roasting stick or utensil and place between two graham crackers.

The marshmallow containing a soft textured chocolate can also be eaten on it's own without roasting or graham crackers. It can been placed atop a mug of hot chocolate or other desired hot beverage, used in baking or other uses that marshmallows are used for.

The drawing, Figure A, attached in this application, shows the inside view of the marshmallow with the soft textured chocolate center.

During experimentation, the following process was used to successfully make the marshmallow with a soft texture chocolate center filling as described in this application.

Step 1

In preparation, ¼ cup cornstarch and ⅓ cup powdered sugar were combined thoroughly.
   Step 2
Cylinder molds 1 & ¼ inches in diameter and 2 inches high with each end open were lightly greased with shortening and then dusted with the cornstarch and powdered sugar mixture, then placed vertically on waxed paper.
   Step 3
The soft texture filling was made by combining
2 ounces unsweetened baking chocolate
1 tablespoon light corn syrup
⅓ cup sweetened condensed milk
Theses ingredients were cooked over low heat and stirred until thoroughly combined
This mixture was then covered and placed in refrigeration for one hour
   Step 4
The chocolate mixture was then removed from refrigeration, measured into 1 teaspoon portions and then formed into cylinder type shapes approximately and then returned to refrigeration.
   Step 5
The marshmallow portion was made as follows:
¼ cup water (approximately 68 degrees Fahrenheit) was placed in a saucepan
Added to the water was 7 grams of unflavored gelatin. This mixture was allowed to set for 5 minutes.
⅔ cups of granulated sugar was then added to this mixture. This mixture was then heated over low heat and stirred continually until the granulated sugar had completely dissolved.
This mixture was then poured into a mixing bowl and to it was added ½ cup light corn syrup, 1/16 teaspoon salt, 1 teaspoon vanilla.
This mixture was then mixed with an electric mixer on high until stiff peaks could be formed.
   Step 6
The marshmallow mixture was then poured into the molds, filling each of them only a third of the way.
The chocolate which was formed earlier was then placed atop the marshmallow filling in the center of the mold.
The marshmallow mixture was then poured into the molds, making sure to completely fill the mold.
   Step 7
The marshmallows with the soft textured chocolate center filling were then allowed to set for 5 hours before the molds were gently removed. The ends of the marshmallow were lightly coated with the cornstarch and powdered sugar mixture on either end before removing from the mold. Once removed from the mold, the entire surface of the marshmallow was lightly coated with the cornstarch and powdered sugar mixture. The marshmallows with the soft textured chocolate center filling were then allowed to set uncovered for another 19 hours before being placed in a sealed plastic bag for storage.

The primary intention for this invention is marshmallows with a soft textured chocolate center filling for the purpose of roasting and use in making smores. This is achieved by placing a roasting stick or other utensil through the center or approximately the center of the marshmallow with the soft textured chocolate center filling and gently roasting over an open flame, not too close as to set it on fire, but close enough that the outer layer of the marshmallow with the soft textured chocolate center filling begins to bubble and caramelize. When the marshmallow with the soft textured chocolate center filling has been roasted, it can then be placed between two graham crackers and eaten as a smore.

1. What I consider to be my invention is a marshmallow with a soft textured chocolate filling.
